(19) United States
(12) Patent Application Publication
(10) Pub. No.: US 2026/0303209 A1
(43) Pub. Date: Oct. 1, 2026

(54) OPTICAL TRANSMISSION DEVICE AND OPTICAL TRANSMISSION METHOD

(71) Applicant: NTT, Inc., Tokyo (JP)

(72) Inventors: Haruka MINAMI, Tokyo (JP); Takeshi SEKI, Tokyo (JP)

(73) Assignee: NTT, Inc., Tokyo (JP)

(21) Appl. No.: 19/489,907

(22) PCT Filed: Jun. 12, 2023
(86) PCT No.: PCT/JP2023/021678

§ 371 Date: Dec. 4, 2025

(51) Int. Cl. H04B 10/079; H04B 10/278; H04B 10/291; H04J 14/02

(52) U.S. Cl. CPC H04B 10/0795; H04B 10/0793; H04B 10/0797; H04B 10/278; H04B 10/2912; H04J 14/028

(57) ABSTRACT

For an input signal requiring wavelength conversion, a WSS of an optical transmission device outputs a wavelength component after wavelength conversion from a cross connect to an output port as a transmission signal and also outputs a wavelength component before the wavelength conversion to a monitoring measurement instrument as an extraction signal, and, for an input signal not requiring wavelength conversion, outputs the wavelength component before the wavelength conversion from the cross connect to the output port as the transmission signal and also outputs the wavelength component after the wavelength conversion to the monitoring measurement instrument as the extraction signal.

### TECHNICAL FIELD

The present invention relates to an optical transmission device and an optical transmission method.

### BACKGROUND ART

Optical transmission devices compatible with wavelength cross-connect (WXC) have been widely used. The WXC function outputs wavelength-multiplexed signal light transmitted from a path on the input side to an arbitrary path on the output side.

Further, in a network to which multi-band transmission is applied, there is also a mode in which a wavelength conversion function for converting a wavelength of an optical signal into another wavelength is added to the optical transmission device. The wavelength conversion function is expected to exhibit an effect of suppressing deterioration in transmission quality caused by interband Raman scattering (Non Patent Literature 1) and an effect of increasing a traffic volume that can be accommodated (Non Patent Literature 2).

### CITATION LIST

### Non Patent Literature

Non Patent Literature 1: H. Kawahara et. al., “Cancellation of Static and Dynamic Power Transitions induced by inter-band Stimulated Raman Scattering in C+L-band WDM Transmission,” 2020 Opto-Electronics and Communications Conference (OECC) (2020) Non Patent Literature 2: M. Nakagawa et. al., “Adaptive Link-by-Link Band Allocation: A Novel Adaptation Scheme in Multi-Band Optical Networks,” 2021 International Conference on Optical Network Design and Modeling (ONDM) (2021)

### SUMMARY OF INVENTION

### Technical Problem

In an optical transmission system that connects a transmission node and a reception node with a relatively-long-distance optical fiber cable and transmits optical signals therebetween, great attenuation of optical signals in the middle of a transmission path and deterioration in transmission quality are expected. Therefore, in order to reliably deliver an optical signal transmitted from the transmission node to the reception node, it is generally necessary to arrange one or more relay nodes in the middle of the transmission path to amplify the attenuated optical signal or correct a bit error or the like that has occurred in the middle of the transmission path.

Each relay node of the optical transmission system usually has an electrical termination processing function. That is, the relay node temporarily converts a received optical signal into an electrical signal and performs relay processing on information of the converted electrical signal. When the information of the electrical signal is processed, it is possible to acquire (monitor) transmission quality data (Pre-FEC BER, amount of dispersion compensation, amount of polarization mode dispersion, and polarization dependent loss) in the relay node.

In a case where a failure occurs in the optical transmission system, it is necessary to specify a location of the failure. For this purpose, first, an entire length of a long-distance transmission path is divided into a plurality of sections for each relay node, and whether or not the failure occurs can be determined for each section.

In a case where each relay node has the electrical termination processing function, the transmission quality data can be acquired for each relay node. Therefore, by comparing the transmission quality data between the relay nodes, it is possible to determine whether or not the failure occurs for each section.

However, the transmission quality data cannot be obtained at the relay node that does not have the electrical termination processing function. Therefore, a large number of optical transmission devices are included in each section for which whether or not the failure occurs can be determined, or a length of the optical fiber cable for each section becomes significantly long. This makes it difficult to specify the failure location.

In view of this, there will be considered a method of generating a wavelength signal after wavelength conversion from a wavelength signal before the wavelength conversion by allowing one optical signal received by a relay node to pass through a wavelength conversion device having an all-optical wavelength conversion (AO-WC) function. In this case, because the wavelength signal before the wavelength conversion is not used for relay, the wavelength signal can be converted into an electrical signal and used for acquiring the transmission quality data.

Therefore, in a case where a failure occurs in an optical network, a location of the failure can be easily specified. Even in a case where a failure does not occur, information useful for failure prediction in the optical network can be obtained. The wavelength signal after the wavelength conversion is relayed to the downstream side without requiring the electrical termination processing and thus does not affect signal delay or deterioration in transmission quality.

However, by allowing optical signals to pass through the wavelength conversion device, not only an optical signal requiring wavelength conversion, but also an optical signal not requiring wavelength conversion in the relay node is input to the relay node.

In this case, in a method in which a relay node has a transmission path that allows an optical signal to pass through the wavelength conversion device and a bypass route that does not allow an optical signal to pass through the wavelength conversion device, the optical signal that does not pass through the wavelength conversion device bypasses the wavelength conversion device by passing through the bypass route and thus is excluded from a target to be monitored.

In view of this, a main object of the present invention is to monitor an optical signal passing through an optical transmission device regardless of the necessity of wavelength band conversion.

### Solution to Problem

To solve the above problem, an optical transmission device of the present invention has the characteristics described below.

The present invention is an optical transmission device that performs optical relay processing of outputting an input signal that is an input optical signal to another device as a transmission signal, the optical transmission device including
a wavelength conversion unit, a first wavelength selective switch (WSS), a cross connect, and a monitoring measurement instrument, in which:
the wavelength conversion unit converts a wavelength of the input signal to the optical transmission device regardless of necessity of wavelength conversion of the input signal and outputs emission light including both wavelength components before and after the wavelength conversion to the first WSS;
for an input signal requiring wavelength conversion, the first WSS outputs the wavelength component of the emission light after the wavelength conversion from the cross connect to an output port as the transmission signal and also outputs the wavelength component of the emission light before the wavelength conversion to the monitoring measurement instrument as an extraction signal, and
for an input signal not requiring wavelength conversion, the first WSS outputs the wavelength component of the emission light before the wavelength conversion from the cross connect to the output port as the transmission signal and also outputs the wavelength component of the emission light after the wavelength conversion to the monitoring measurement instrument as the extraction signal; and
the monitoring measurement instrument electrically terminates the extraction signal output from the first WSS to detect transmission quality data of the extraction signal.

### Advantageous Effects of Invention

According to the present invention, it is possible to monitor an optical signal passing through an optical transmission device regardless of the necessity of wavelength band conversion.

### BRIEF DESCRIPTION OF DRAWINGS

FIG. 1 is a configuration diagram of an optical transmission system according to the present embodiment.

FIG. 2 is a configuration diagram of an all-optical wavelength conversion unit included in the optical transmission system of FIG. 1 according to the present embodiment.

FIG. 3 is a flowchart showing an example of a processing procedure in which transmission quality data of a signal requiring wavelength conversion is detected in an optical transmission management method by the optical transmission system according to the present embodiment.

FIG. 4 is a flowchart showing an example of a processing procedure in which transmission quality data of a signal not requiring wavelength conversion is detected in an optical transmission management method by the optical transmission system according to the present embodiment.

FIG. 5 is a hardware configuration diagram of an optical transmission device according to the present embodiment.

FIG. 6 is graphs showing a wavelength distribution in a case where transmission quality data of a signal requiring wavelength conversion is detected by using a detector for each wavelength regarding the present embodiment.

FIG. 7 is graphs showing a wavelength distribution in a case where transmission quality data of a signal not requiring wavelength conversion is detected by using a detector for each wavelength regarding the present embodiment.

FIG. 8 is graphs showing a wavelength distribution in a case where a single detector including a wavelength filter is used instead of the detector for each wavelength in the state of FIG. 6 regarding the present embodiment.

FIG. 9 is graphs showing a wavelength distribution in a case where a single detector including a wavelength filter is used instead of the detector for each wavelength in the state of FIG. 7 regarding the present embodiment.

FIG. 10 is graphs showing a wavelength distribution in a case where an optical signal requiring wavelength conversion and an optical signal not requiring wavelength conversion are input to the same wavelength converter regarding the present embodiment.

FIG. 11 is a configuration diagram of an optical transmission device showing a first example of the optical transmission device of FIG. 1 according to the present embodiment.

FIG. 12 is a configuration diagram of an optical transmission device showing a second example of the optical transmission device of FIG. 1 according to the present embodiment.

FIG. 13 is a configuration diagram of an optical transmission device showing a third example of the optical transmission device of FIG. 1 according to the present embodiment.

FIG. 14 is a configuration diagram of an optical transmission device showing a fourth example of the optical transmission device of FIG. 1 according to the present embodiment.

FIG. 15 is a configuration diagram of an optical transmission device showing a fifth example of the optical transmission device of FIG. 1 according to the present embodiment.

### DESCRIPTION OF EMBODIMENTS

Hereinafter, an embodiment of the present invention will be described in detail with reference to the drawings.

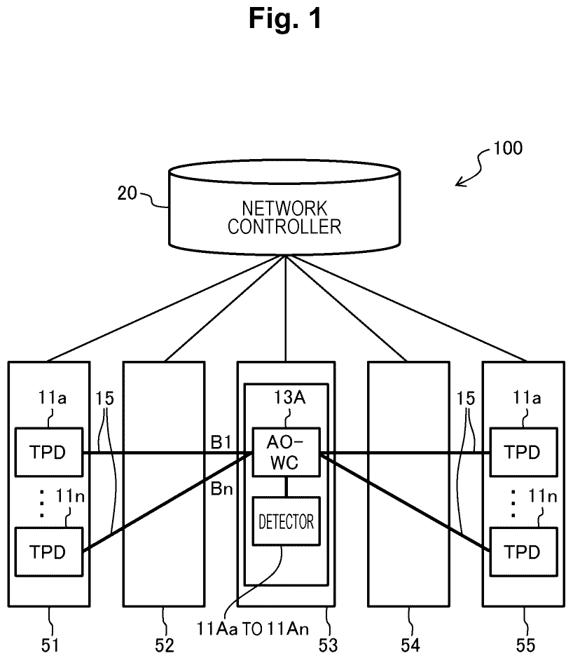

FIG. 1 is a configuration diagram of an optical transmission system 100.

The optical transmission system 100 includes five optical transmission devices 51 to 55 and a network controller 20. The five optical transmission devices 51 to 55 are arranged in a line at positions separated from each other by a certain distance, for example. Each of the optical transmission devices 51 to 55 of FIG. 1 has a function of transmitting a wavelength division multiplexing (WDM) optical signal in which optical signals having a plurality of wavelengths are multiplexed.

The five optical transmission devices 51 to 55 are connected to each other in series via one or a plurality of optical fiber cables 15 used as a transmission path of WDM optical signals. Each of the optical transmission devices 51 and 55 that are provided at end positions of a network and function as a transmission node or a reception node includes a plurality of transponders (TPDs) 11a to 11n capable of performing processing of WDM optical signals.

The network controller 20 manages an entire optical communication network including the optical transmission devices 51 to 55 and the optical fiber cable 15. For example, in a case where any failure occurs in the optical communication network, the network controller 20 can generate information useful for specifying an occurrence location of the failure.

For example, in a case where the optical transmission device 51 on one end side of the communication network transmits data to the optical transmission device 55 on the other end side thereof, the optical transmission device 51 serves as the transmission node, and the optical transmission device 55 serves as the reception node. Each of the optical transmission devices 52 to 54 between the transmission node and the reception node is used as a relay node.

The optical transmission device 51 serving as the transmission node converts data to be transmitted from an electrical signal into an optical signal of a predetermined wavelength in each of the TPDs 11a to 11n and transmits a WDM optical signal in which a plurality of wavelengths is multiplexed to the optical fiber cable 15. The optical transmission device 55 serving as the reception node receives the WDM optical signal from the optical fiber cable 15. The optical transmission device 55 separates the received WDM optical signal for each wavelength, converts the optical signal into an electrical signal in each of the TPDs 11a to 11n, and acquires received data through the processing on the electrical signal.

In the optical transmission system 100, the optical transmission device 53 used as one relay node includes an all-optical wavelength conversion unit 13A having an AO-WC function. The optical transmission device 53 also includes a plurality of TPDs 11a to 11n corresponding to WDM optical signals.

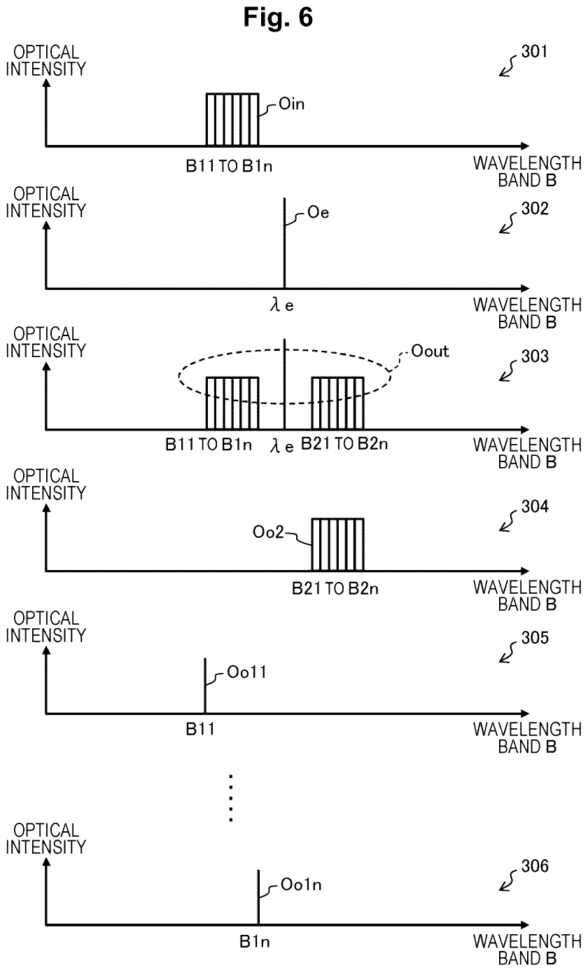

The all-optical wavelength conversion unit 13A in the optical transmission device 53 handles the following optical signals as described later with reference to FIG. 6.
An input signal (input optical signal Oin in FIG. 6) is an optical signal input to the all-optical wavelength conversion unit 13A and includes components of wavelength bands B11 to B1n.
A transmission signal (transmission optical signal Oo2 in FIG. 6) is an optical signal output from the all-optical wavelength conversion unit 13A to the downstream-side optical transmission device 54.
Extraction signals (emission light beams Oo11 to Oon in FIG. 6) are optical signals that are output from the all-optical wavelength conversion unit 13A to detectors 11Aa to 11An and whose transmission quality data is detected (monitored).

That is, the optical transmission device 53 performs optical relay processing of outputting an input signal that is an input optical signal to another device as a transmission signal.

The all-optical wavelength conversion unit 13A performs wavelength conversion processing on a WDM optical signal input from the upstream-side optical fiber cable 15 to the optical transmission device 53 as an optical signal as it is, generates a WDM optical signal having a different wavelength from the input, and transmits the WDM optical signal to the downstream-side optical fiber cable 15.

The all-optical wavelength conversion unit 13A can extract unnecessary optical components separated from the WDM optical main signal relayed by the optical transmission device 53 and input the unnecessary optical components to the detectors 11Aa to 11An in the optical transmission device 53.

The detectors 11Aa to 11An, as well as the TPDs 11a to 11n, have the electrical termination processing function, but do not have a function of transmitting an optical signal. That is, each of the detectors 11Aa to 11An has a function of converting an input optical signal into an electrical signal and a function of processing this electrical signal to detect the transmission quality data.

The transmission quality data is, for example, a pre-forward error correction (Pre-FEC) bit error rate (BER), an amount of dispersion compensation, an amount of polarization mode dispersion, or a polarization dependent loss.

That is, the optical transmission device 53 relays the WDM optical main signal to be relayed as an optical signal as it is and transmits the WDM optical main signal to the downstream-side optical fiber cable 15 without performing the electrical termination processing on the WDM optical main signal, thereby preventing an increase in delay caused by the relay processing. Further, it is unnecessary to use an optical splitter in order to extract optical signals to be input to the detectors 11Aa to 11An, thereby preventing a decrease in optical intensity of the WDM optical main signal.

The all-optical wavelength conversion unit 13A extracts the unnecessary optical components separated from the WDM optical main signal to be relayed as extraction signals and inputs the extraction signals to the detectors 11Aa to 11An in the optical transmission device 53. Thus, the detectors 11Aa to 11An can detect the transmission quality data at a node position of the optical transmission device 53.

Therefore, the network controller 20 can acquire the transmission quality data of the relay node such as the optical transmission device 53 that does not perform the electrical termination processing. For example, in a case where a failure occurs, the network controller 20 can determine whether or not a failure occurs for each section on the basis of the transmission quality data at a position of each relay node.

The optical transmission device 53 can switch wavelength bands between the transmission signal and the extraction signal depending on whether or not the signal is a signal requiring wavelength conversion.
For a signal requiring wavelength conversion, wavelength bands B21 to B2n (wavelength bands after wavelength conversion) are set for the transmission signal, and wavelength bands B11 to B1n (wavelength bands before wavelength conversion) are set for the extraction signal.
For a signal not requiring wavelength conversion, wavelength bands B11 to B1n (wavelength bands before wavelength conversion) are set for the transmission signal, and wavelength bands B21 to B2n (wavelength bands after wavelength conversion) are set for the extraction signal.

Therefore, the optical transmission device 53 can acquire the transmission quality data even in a case where wavelength conversion is not performed.

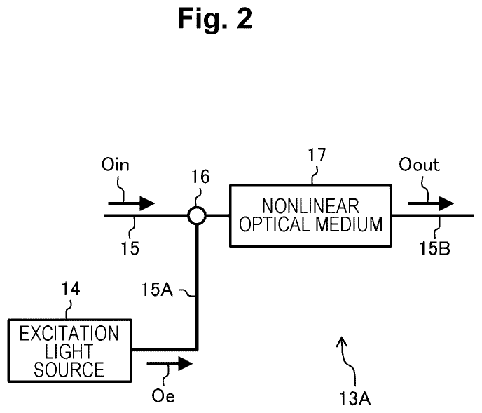

FIG. 2 is a configuration diagram of the all-optical wavelength conversion unit 13A included in the optical transmission system 100 of FIG. 1. The all-optical wavelength conversion unit 13A includes an excitation light source 14, an optical fiber 15A, an optical multiplexer 16, and a nonlinear optical medium 17.

The excitation light source 14 generates excitation light Oe of a predetermined wavelength λe. The excitation light Oe generated by the excitation light source 14 passes through the optical fiber 15A and enters the optical multiplexer 16. The wavelength λe of the excitation light Oe is different from (does not overlap with) the wavelength bands B1 to Bn included in the input optical signal Oin of the WDM. The optical intensity of the excitation light Oe is sufficiently larger than that of the input optical signal Oin of the WDM.

The optical multiplexer 16 generates light by multiplexing the input optical signal Oin of the WDM input from the optical fiber cable 15 and the excitation light Oe input from the optical fiber 15A and transmits the light to an incident end of the nonlinear optical medium 17.

The nonlinear optical medium 17 has nonlinear optical characteristics and generates an optical signal having a different wavelength from incident light. The nonlinear optical medium 17 is configured as, for example, any of a highly nonlinear fiber (HNLF), a periodically poled lithium niobate (PPLN), and a semiconductor optical amplifier (SOA).

Then, emission light Oout is emitted from an output end of the nonlinear optical medium 17. The emission light Oout includes both a wavelength band of the input optical signal Oin before wavelength conversion and a wavelength band of the input optical signal Oin after the wavelength conversion (described later with reference to a graph 303 in FIG. 6).

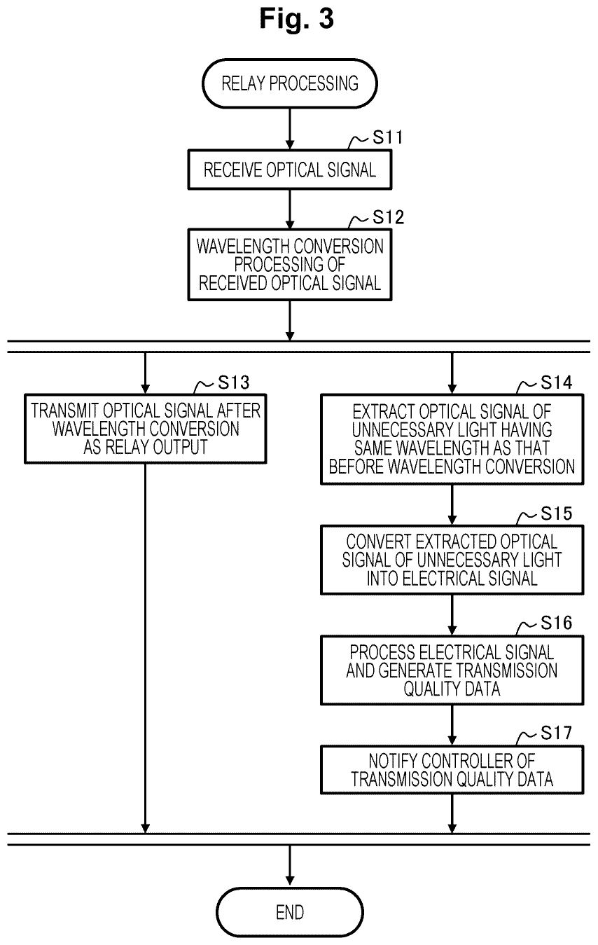

FIG. 3 is a flowchart showing an example of a processing procedure in which transmission quality data of a signal requiring wavelength conversion is detected in an optical transmission management method by the optical transmission system 100.

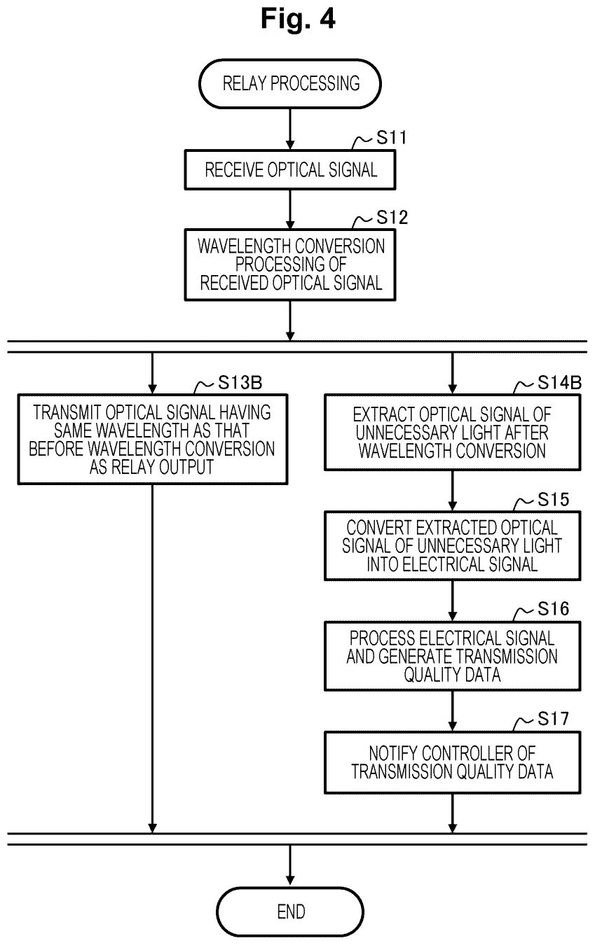

FIG. 4 is a flowchart showing an example of a processing procedure in which transmission quality data of a signal not requiring wavelength conversion is detected in the optical transmission management method by the optical transmission system 100.

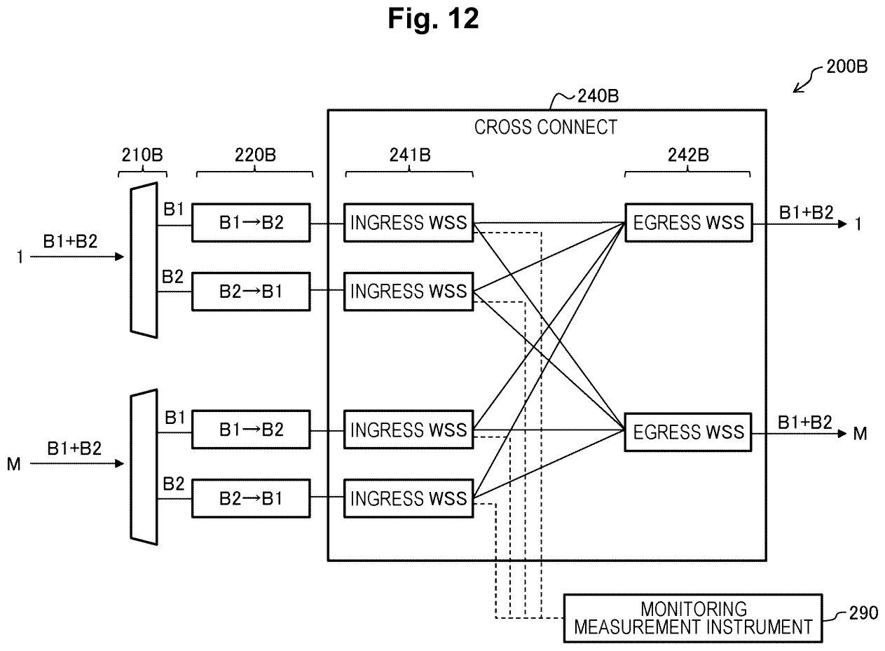

Step S13 in FIG. 3 is replaced with step S13B in FIG. 4, and step S14 in FIG. 3 is replaced with step S14B in FIG. 4. The processing procedures of FIGS. 3 and 4 can be used to manage the optical transmission system 100 of FIG. 12, for example. In this optical transmission system 100, at the node position of the optical transmission device 53 that relays communication, the optical transmission device 53 receives an input optical signal Oin from the upstream-side optical fiber cable 15 in step S11, and the all-optical wavelength conversion unit 13A executes wavelength conversion on the input optical signal Oin in step S12.

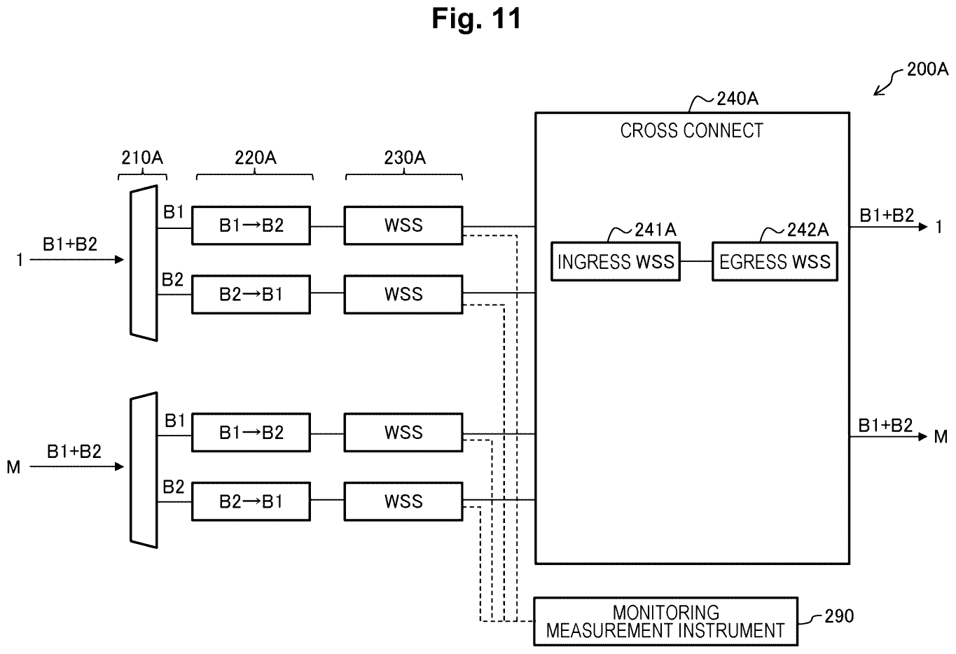

First, when the input optical signal Oin is a signal requiring wavelength conversion, an optical demultiplexer (WSS 230A in FIG. 11, hereinafter, referred to as “optical demultiplexer”) in the all-optical wavelength conversion unit 13A transmits a transmission optical signal Oo2 (transmission signal) after wavelength conversion to the downstream-side optical fiber cable 15 as a relay output from a cross connect 240A in FIG. 11 (step S13 in FIG. 3). Then, the optical demultiplexer extracts an emission light beam Ool having the same wavelength as that before the wavelength conversion, that is, unnecessary light that is not used for relaying communication as an extraction signal in step S14.

Meanwhile, when the input optical signal Oin is a signal not requiring wavelength conversion, the optical demultiplexer in the all-optical wavelength conversion unit 13A transmits an optical signal having the same wavelength as that before the wavelength conversion as a relay output (step S13B in FIG. 4). Then, the optical demultiplexer extracts an optical signal of unnecessary light after the wavelength conversion as an extraction signal in step S14B.

A detector (monitoring measurement instrument 290 in FIG. 11, hereinafter, referred to as “detector”) in the optical transmission device 53 receives input of the extraction signal of the unnecessary light extracted by the optical demultiplexer and converts the extraction signal into an electrical signal in step S15.

The detector may be a detector corresponding to reception units of the TPDs 11a to 11n, a spectrum analyzer, a polarization monitor, a power meter, or the like. The detector corresponding to the reception units of the TPDs 11a to 11n converts the unnecessary light into the electrical signal and processes the electrical signal, thereby acquiring transmission quality data in step S16. In a case of the spectrum analyzer, a signal-to-noise ratio is acquired. In a case of the polarization monitor, a polarization state of the optical signal is acquired, and in a case of the power meter, an optical intensity is acquired.

The optical transmission device 53 associates the transmission quality data detected by the detector therein with the relay node position and notifies the network controller 20 of the transmission quality data in step S17.

Therefore, by performing the relay processing in FIG. 3, the network controller 20 can also obtain the transmission quality data of a relay node in which the electrical termination processing for a transmitted optical signal is omitted.

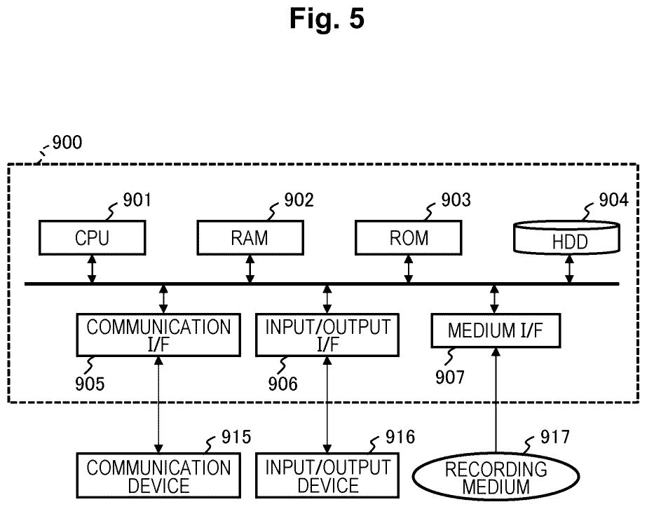

FIG. 5 is a hardware configuration diagram of the optical transmission device 53.

The optical transmission device 53 is configured as a computer 900 including a CPU 901, a RAM 902, a ROM 903, an HDD 904, a communication I/F 905, an input/output I/F 906, and a medium I/F 907.

The communication I/F 905 is connected to an external communication device 915. The input/output I/F 906 is connected to an input/output device 916. The medium I/F 907 reads and writes data from and to a recording medium 917. The CPU901 controls each unit by executing a program (optical transmission program) read into the RAM902. The program (application, also abbreviated as app.) can be distributed via a communication line or be distributed by being recorded in the recording medium 917 such as a CD-ROM.

Hereinafter, the wavelength distribution of the optical signal processed by the optical transmission device 53 of FIG. 1 will be described with reference to FIGS. 6 to 10.

FIG. 6 is graphs showing a wavelength distribution in a case where transmission quality data of a signal requiring wavelength conversion is detected by using the detectors 11Aa to 11An for each wavelength. The horizontal axis of the graph represents the wavelength, and the vertical axis thereof represents the optical intensity.

A graph 301 indicates that an input signal (input optical signal Oin) input from the upstream-side optical fiber cable 15 to the optical transmission device 53 includes components of a plurality of multiplexed wavelength bands B11 to B1n.

A graph 302 indicates that the excitation light Oe generated by the excitation light source 14 includes only a component of a single wavelength λe. The optical intensity of the excitation light Oe is sufficiently larger than that of the input optical signal Oin.

The all-optical wavelength conversion unit 13A converts the wavelengths of the input signal regardless of the necessity of the wavelength conversion of the input signal to the optical transmission device 53 and outputs the emission light Oout including both the wavelength components before and after the wavelength conversion to the optical demultiplexer (WSS 230A).

A graph 303 indicates that the emission light Oout emitted from the nonlinear optical medium 17 of the all-optical wavelength conversion unit 13A includes the optical components of the wavelength bands B11 to B1n , the wavelength λe, and the wavelength bands B21 to B2n. Those wavelengths of the emission light Oout are generated on the basis of the wavelengths included in the input optical signal Oin, the wavelength λe of the excitation light Oe, and the nonlinear optical characteristics of the nonlinear optical medium 17.

The optical components of the wavelength bands B21 to B2n are optical components generated by the wavelength conversion of the input optical signal Oin along with the passage through the nonlinear optical medium 17. The optical intensities of the components of the wavelength bands B21 to B2n included in the emission light Oout are equal to those of the input optical signal Oin. That is, the wavelength conversion can be performed without attenuating the optical intensities.

The optical intensities of the components of the wavelength bands B11 to B1n included in the emission light Oout are equal to those of the input optical signal Oin. That is, the optical signal of the wavelength bands B11 to B1n that are the same as those before the wavelength conversion, which is other than the main signal, can be extracted from the output of the nonlinear optical medium 17 with a sufficiently large optical intensity.

A graph 304 shows the transmission optical signal Oo2.

By demultiplexing in the optical demultiplexer, the transmission optical signal Oo2 including the optical components of the wavelength bands B21 to B2n is extracted from one output of the optical demultiplexer, and the transmission optical signal Oo2 is transmitted to the downstream-side optical fiber cable 15 as the WDM optical main signal (transmission signal) of the relay output.

A graph 305 shows the emission light beam Oo11. A graph 306 shows the emission light beam Oo1n.

By the demultiplexing in the optical demultiplexer, the emission light beams Oo11 to Oo1n including the optical components of the same wavelength bands B11 to B1n as those before the wavelength conversion are extracted to another output of the optical demultiplexer. The emission light beams Oo11 to Oo1n are input as extraction signals to the plurality of detectors 11Aa to 11An via the optical fibers 15B for each wavelength.

Here, because the emission light beams Oo11 to Oo1n having a sufficiently large optical intensity are input into the detectors 11Aa to 11An, the detectors 11Aa to 11An can easily detect the transmission quality data for each wavelength at the position of the corresponding relay node. As a matter of course, each of the detectors 11Aa to 11An converts the input optical signal into the electrical signal therein and processes the electrical signal, thereby detecting the transmission quality data.

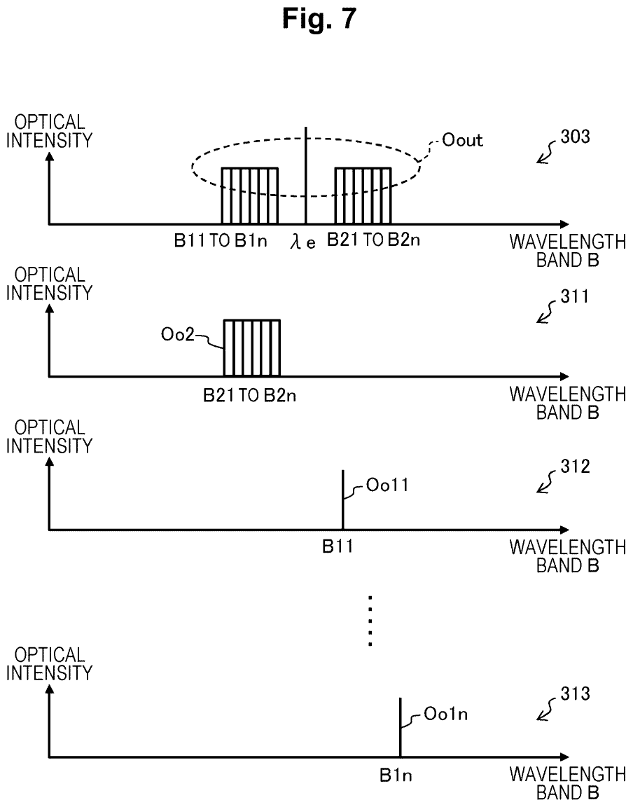

FIG. 7 is graphs showing a wavelength distribution in a case where transmission quality data of a signal not requiring wavelength conversion is detected by using the detectors 11Aa to 11An for each wavelength.

The graph 303 is as described in FIG. 6.

When compared with the graph 304 of FIG. 6, in the wavelength distribution of the transmission optical signal Oo2 in a graph 311, the wavelength bands B21 to B2n after the wavelength conversion are replaced with the wavelength bands B11 to B1n before the wavelength conversion.

When compared with graphs 305 and 306 of FIG. 6, in the wavelength distributions of the emission light beams Oo11 to Oo1n in graphs 312 and 313, the wavelength bands B11 to B1n before the wavelength conversion are replaced with the wavelength bands B21 to B2n after the wavelength conversion.

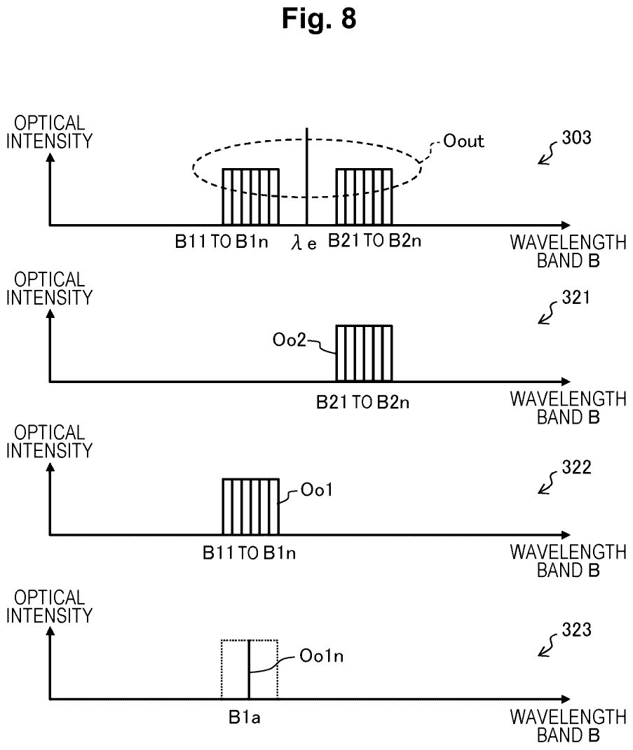

FIG. 8 is graphs showing a wavelength distribution in a case where a single detector including a wavelength filter is used instead of the detectors 11Aa to 11An for each wavelength in the state of FIG. 6.

The graph 303 is as described in FIG. 6.

The graph 321 is as described in the graph 304 of FIG. 6.

A graph 322 shows a signal input to the wavelength filter of the detector. By the demultiplexing in the optical demultiplexer, the emission light beam Ool including the optical components of the same wavelength bands B11 to B1n as those before the wavelength conversion is extracted to another output of the optical demultiplexer, and the emission light beam Ool is input to the wavelength filter.

A graph 323 shows a signal that is output from the wavelength filter of the detector and is a target to be detected. The wavelength filter selectively extracts the emission light beam Oon of one wavelength band Bla from the wavelength bands B11 to B1n.

Therefore, it is unnecessary to install the detectors 11Aa to 11An for each wavelength in the optical transmission device 53. In this case, the single detector sequentially selects the wavelength bands B11 to B1n included in the WDM optical signal of the emission light beam Oo1, converts the signal into an electrical signal in order for each wavelength, and processes the electrical signal, thereby detecting the transmission quality data at the position of the relay node for each wavelength.

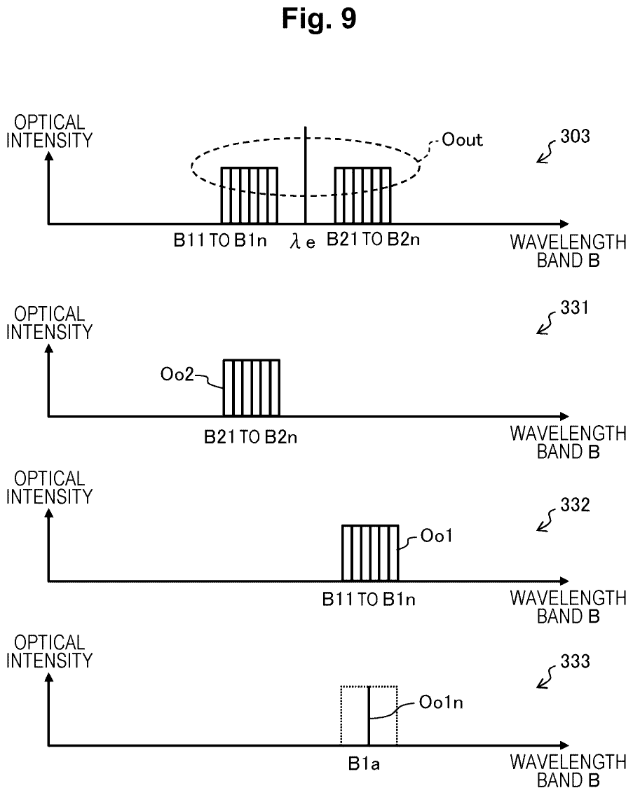

FIG. 9 is a graph showing a wavelength distribution in a case where a single detector including a wavelength filter is used instead of the detectors 11Aa to 11An for each wavelength in the state of FIG. 7.

The graph 303 is as described in FIG. 6.

When compared with the graph 321 of FIG. 8, in the wavelength distribution of the transmission optical signal Oo2 in a graph 331, the wavelength bands B21 to B2n after the wavelength conversion are replaced with the wavelength bands B11 to B1n before the wavelength conversion.

When compared with graphs 322 and 323 of FIG. 8, in the wavelength distributions of the emission light beams Oo11 to Oo1n in graphs 332 and 333, the wavelength bands B11 to B1n before the wavelength conversion are replaced with the wavelength bands B21 to B2n after the wavelength conversion.

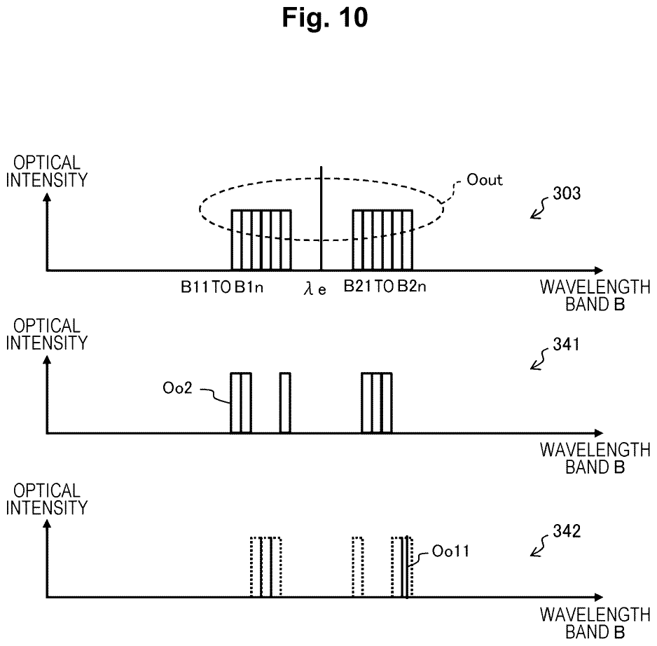

FIG. 10 is graphs showing a wavelength distribution in a case where an optical signal requiring wavelength conversion and an optical signal not requiring wavelength conversion are input to the same wavelength converter.

The graph 303 is as described in FIG. 6.

A graph 341 shows the transmission optical signal Oo2. The wavelength distribution of the transmission optical signal Oo2 exists in the wavelength bands B11 to B1n before the wavelength conversion and also in the wavelength bands B21 to B2n after the wavelength conversion.

A graph 342 shows the emission light beam Oo11. The wavelength distribution of the emission light beam Oo11 also exists in the wavelength bands B11 to B1n before the wavelength conversion and also in the wavelength bands B21 to B2n after the wavelength conversion.

Hereinafter, details of the optical transmission device 53 in FIG. 1 of the present embodiment will be described with reference to FIGS. 11 to 15.

FIGS. 11 to 13 show examples where a wavelength group input from the input port of the optical transmission device 53 includes two wavelength bands B1 and B2.

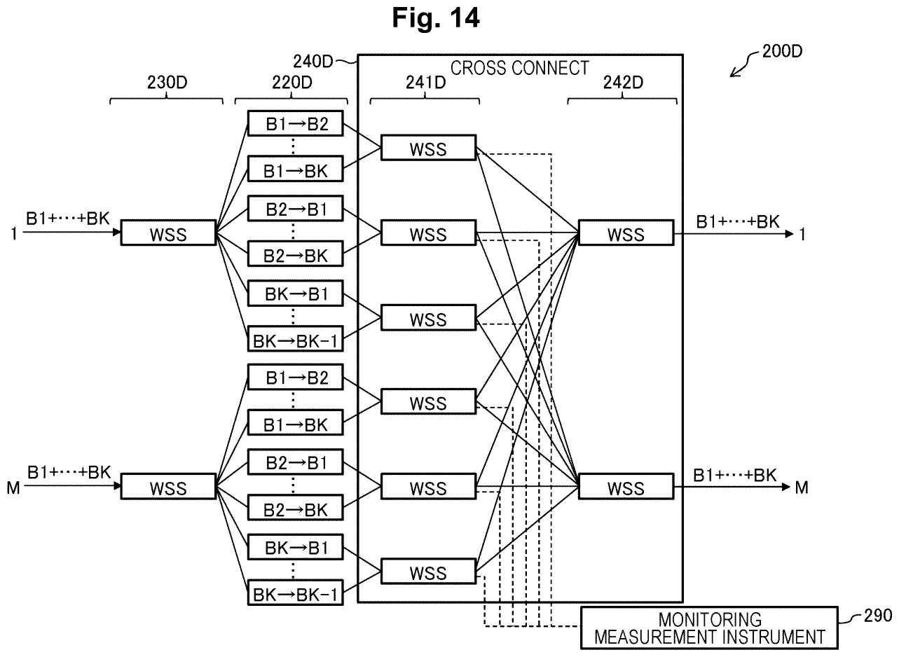

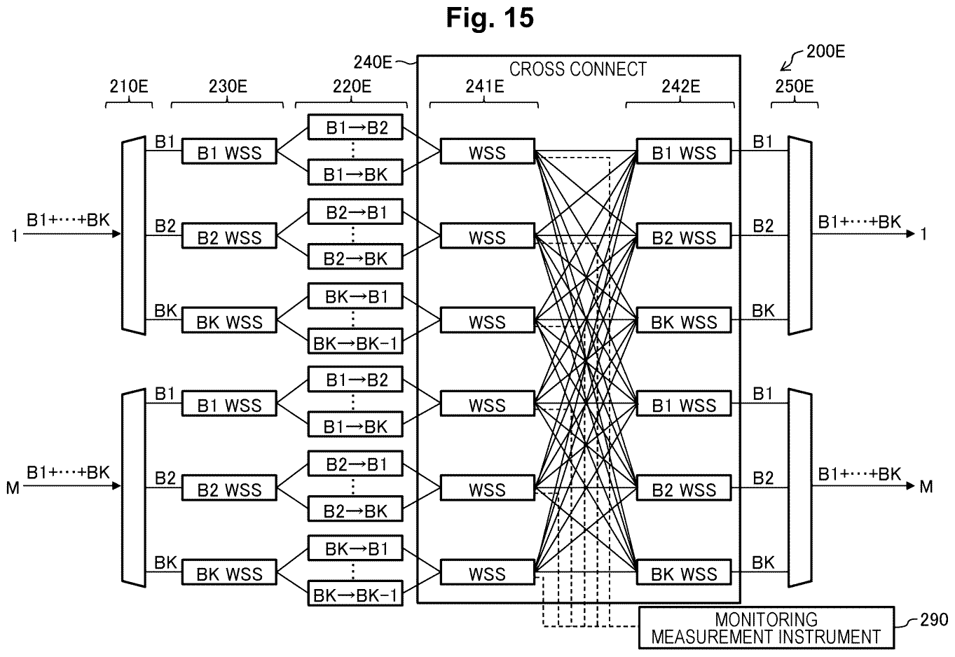

FIGS. 14 and 15 show examples where a wavelength group input from the input port of the optical transmission device 53 includes a plurality of wavelength bands B1, B2, . . . , and BK (K is a natural number of 2 or more).

The input wavelength group may include a plurality of wavelength bands, or a plurality of partial wavelength regions may exist in one wavelength band.

FIG. 11 is a configuration diagram of an optical transmission device 200A showing a first example of the optical transmission device 53 of FIG. 1.

In the optical transmission device 200A, DEMUXs 210A, wavelength conversion units 220A, the WSSs 230A (first WSSs), and the cross connect 240A (ingress WSS 241A and egress WSS 242A that are wavelength selective switches) are connected in order from an upstream-side input port (1 and M on the left side of FIG. 11) of an optical signal to a downstream-side output port (1 and M on the right side of FIG. 11) thereof. The WSSs 230A and the monitoring measurement instrument 290 are connected.

Note that the components in FIG. 11 include those already described as follows.
The all-optical wavelength conversion unit 13A of FIG. 1 is implemented as the wavelength conversion unit 220A of FIG. 11.
The detectors 11Aa to 11An of FIG. 1 are implemented as the monitoring measurement instrument 290 of FIG. 11.
The optical demultiplexer in the all-optical wavelength conversion unit 13A described with reference to FIG. 3 is implemented as the WSS 230A of FIG. 11.

The DEMUX 210A is a demultiplexer that separates a wavelength group (signal of the wavelength bands B1+B2) input from the input port of the optical transmission device 200A into the wavelength bands B1 and B2. The optical transmission device 200A connects the DEMUX 210A on the input port side of the wavelength conversion unit 220A. The DEMUX 210A separates a signal including an individual wavelength component that can be converted by the wavelength conversion unit 220A from an input signal including a plurality of wavelength components and outputs the separated signals to the respective wavelength conversion units 220A.

Each wavelength conversion unit 220A generates a wavelength signal of the other wavelength band (e.g. the wavelength band B2) from a wavelength signal (e.g. the wavelength band B1) input from the DEMUX 210A and outputs a signal of a wavelength group including the two wavelength bands B1 and B2 (the emission light Oout in FIG. 6) to the WSS 230A.

The WSS 230A is a wavelength selective switch that demultiplexes the emission light Oout output from the wavelength conversion unit 220A into a transmission signal and an extraction signal as follows. The following are examples of wavelength conversion from the wavelength band B1 into the wavelength band B2.
For an input signal requiring wavelength conversion, the WSS 230A outputs a wavelength component (wavelength band B2) of the emission light Oout after the wavelength conversion as a transmission signal to the output port through the cross connect 240A. The WSS 230A outputs a wavelength component (wavelength band B1) of the emission light Oout before the wavelength conversion as an extraction signal to the monitoring measurement instrument 290.
For an input signal not requiring wavelength conversion, the WSS 230A outputs a wavelength component (wavelength band B1) of the emission light Oout before the wavelength conversion as a transmission signal to the output port through the cross connect 240A. The WSS 230A outputs a wavelength component (wavelength band B2) of the emission light Oout after the wavelength conversion as an extraction signal to the monitoring measurement instrument 290.

The above output control of the WSS 230A is set to the WSS 230A from the network controller 20 in advance, for example.

The cross connect 240A selects a wavelength from the ingress WSS 241A located on the ingress side to the output port of the optical transmission device 200A via the egress WSS 242A located on the egress side without performing the electrical termination processing on the transmission signal.

The monitoring measurement instrument 290 detects the transmission quality data by electrically terminating the extraction signal output from the WSS 230A. In the optical transmission device 200A of FIG. 11, a configuration in which extraction signals output on the basis of input signals input from a plurality of input ports are handled in common has been described. Meanwhile, a plurality of monitoring measurement instruments 290 (for respective input ports) may be arranged in the optical transmission device 200A.

With the above configuration, even for a signal not requiring wavelength conversion, an extraction signal is output from the WSS 230A to the monitoring measurement instrument 290 without bypassing the wavelength conversion unit 220A. That is, the optical transmission device 200A has a configuration in which the wavelength conversion unit 220A is arranged on the input port side such that all optical signals input to the optical transmission device 200A pass through the wavelength conversion unit 220A. Therefore, the monitoring method can be applied to all the optical signals.

Because the wavelength group input to the optical transmission device 200A includes the two wavelength bands B1 and B2, the number of optical components through which an optical signal passes is set to a relatively small number, that is, four in total of “the wavelength conversion unit 220A→the WSS 230A→the ingress WSS 241A→the egress WSS 242A”. Therefore, it can be expected to minimize deterioration in transmission quality caused by passing through the optical components.

FIG. 12 is a configuration diagram of an optical transmission device 200B showing a second example of the optical transmission device 53 of FIG. 1.

In the optical transmission device 200B, DEMUXs 210B, wavelength conversion units 220B, and a cross connect 240B (ingress WSSs 241B (first WSSs) and egress WSSs 242B) are connected in order from the input port.

The WSSs 230A and the ingress WSS 241A in the optical transmission device 200A of FIG. 11 are integrated into the ingress WSSs 241B in the optical transmission device 200B of FIG. 12. That is, the function of the WSS 230A is arranged as the ingress WSS 241B on the ingress side in the cross connect 240A.

Therefore, the optical transmission device 200B can be expected to further reduce deterioration in transmission quality by further reducing the number of optical components through which an optical signal passes, as compared with the optical transmission device 200A.

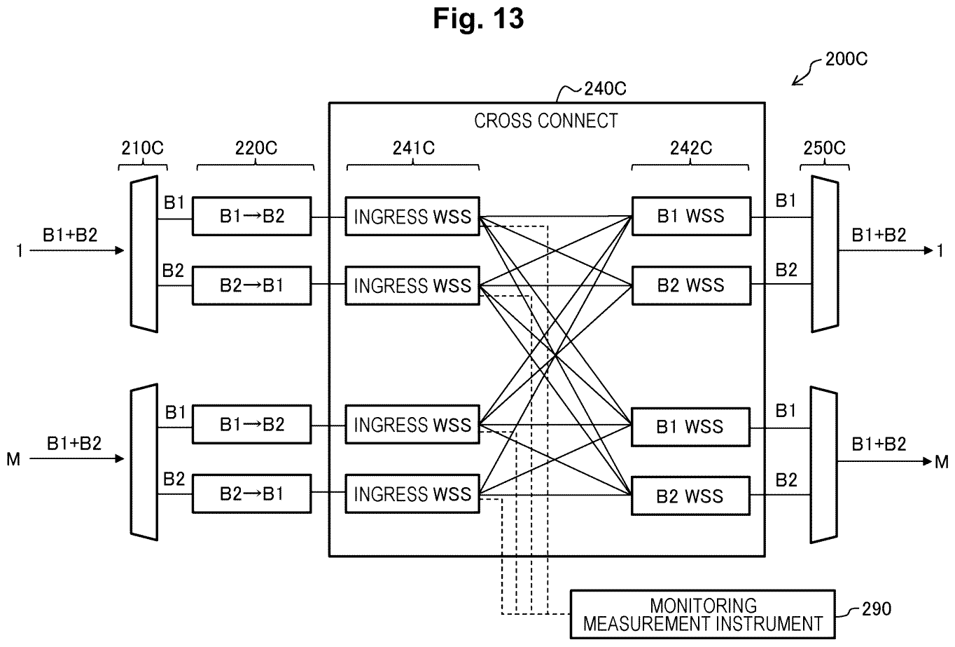

FIG. 13 is a configuration diagram of an optical transmission device 200C showing a third example of the optical transmission device 53 of FIG. 1.

In the optical transmission device 200C, DEMUXs 210C, wavelength conversion units 220C, a cross connect 240C (ingress WSSs 241C (first WSSs) and egress WSSs 242C), and MUXs 250C are connected in order from the input port.

The optical transmission device 200C makes the following changes to the optical transmission device 200B of FIG. 12.
The multi-band egress WSSs 242B are replaced with the single-band egress WSSs 242C. For example, the “B1 WSS” on the upper side is a WSS compatible with a single band of the wavelength band B1. Similarly, hereinafter, a single-band WSS among the WSSs is indicated by “Bi WSS” (i=1, 2, . . . ) and receives input of the wavelength band Bi only.
The MUX 250C that multiplexes signal light beams of the respective wavelength bands is connected on the downstream side of the egress WSSs 242C, and the MUX 250C is connected to the output port. The MUX 250C is a multiplexer that multiplexes signal light beams of a plurality of wavelength bands into one signal.

That is, the optical transmission device 200C connects the MUX 250C on the output port side of the cross connect 240C. The MUX 250C outputs, from the output port, a signal in which transmission signals of individual wavelength components output by the cross connect 240C are multiplexed.

According to the optical transmission device 200C, in addition to the effect of the optical transmission device 200B, an optical amplifier suitable for each wavelength group (low-cost optical amplifier that amplifies only a single wavelength band) can be arranged because optical signals of the wavelength bands B1 and B2 are transmitted between the DEMUXs 210C and the wavelength conversion units 220C and between the egress WSSs 242C and the MUXs 250C.

FIG. 14 is a configuration diagram of an optical transmission device 200D showing a fourth example of the optical transmission device 53 of FIG. 1.

In the optical transmission device 200D, WSSs 230D (second WSSs), wavelength conversion units 220D, and a cross connect 240D (WSSs 241D (first WSSs) and WSSs 242D) are connected in order from the input port. A wavelength group input from the input port of the optical transmission device 200D includes a plurality of wavelength bands B1, B2, . . . , and BK.
The all-optical wavelength conversion unit 13A of FIG. 1 is implemented as the wavelength conversion unit 220D of FIG. 14.
The detectors 11Aa to 11An of FIG. 1 are implemented as the monitoring measurement instrument 290 of FIG. 14.
The optical demultiplexer in the all-optical wavelength conversion unit 13A described with reference to FIG. 3 is implemented as the WSS 241D of FIG. 14.

The optical transmission device 200D connects the WSSs 230D on the input port side of the wavelength conversion unit 220D.

The WSS 230D demultiplexes a signal including an individual wavelength component that can be converted by the wavelength conversion unit 220D from an input signal including a plurality of wavelength components and outputs the demultiplexed signals to the respective wavelength conversion units 220D.

That is, the WSS 230D demultiplexes optical signals of the plurality of wavelength bands B1, B2, . . . , and BK input from the input port into optical signals of single wavelength bands that can be handled by the respective wavelength conversion units 220D. For example, the wavelength conversion unit 220D “B1→B2” on the top converts the input wavelength band B1 into the wavelength band B2 and outputs an optical signal of the wavelength bands B1 and B2. Therefore, among the input optical signals of the plurality of wavelength bands B1, B2,. and BK, the WSS 230D outputs the optical signal of the wavelength band B1 to the wavelength conversion unit 220D “B1-B2”.

FIG. 15 is a configuration diagram of an optical transmission device 200E showing a fifth example of the optical transmission device 53 of FIG. 1.

In the optical transmission device 200E, DEMUXs 210E, WSSs 230E, wavelength conversion units 220E, a cross connect 240E (WSSs 241E (first WSSs) and WSSs 242E), and MUXs 250E are connected in this order from the input port. The optical transmission device 200E makes the following changes to the optical transmission device 200D of FIG. 14.
The (multi-band) WSSs 230D of FIG. 14 are replaced with the (single-band) WSSs 230E of FIG. 15. With this replacement, when the DEMUXs 210E are arranged on the upstream side of the WSSs 230E, the WSSs 230E receive input of a single wavelength band.
The (multi-band) WSSs 242D of FIG. 14 are replaced with the (single-band) WSSs 242E of FIG. 15. With this replacement, when the MUXs 250E are arranged on the downstream side of the WSSs 242E, the WSSs 230E receive and output a single wavelength band.

Therefore, the number of WSSs in the optical transmission device 200E is larger than that in the optical transmission device 200D, but the device cost can be reduced by reducing the multi-band WSSs.

According to the optical transmission device 200E, in addition to the effect of the optical transmission device 200D, an optical amplifier suitable for each wavelength group can be arranged because optical signals of the wavelength bands B1 and B2 are transmitted between the DEMUXs 210E and the WSSs 230E and between the WSSs 242E and the MUXs 250E.

The optical transmission device 200A of the first example is desirably applied as a core node of a core network having a large number of input/output ports because the number of times an optical signal passes through the WSS is large as compared with the second to fifth examples.

Meanwhile, the second example (optical transmission device 200B) to the fifth example (optical transmission device 200E) are desirably applied to a simple network configuration such as a ring network having a small number of input/output ports.

The second example (optical transmission device 200B) and the fourth example (optical transmission device 200D) are suitable for an application of reducing a space for housing the entire device because the number of optical components to be used is small.

### Advantageous Effects

The optical transmission device 200A of the present invention is the optical transmission device 200A that performs optical relay processing of outputting an input signal that is an input optical signal to another device as a transmission signal, the optical transmission device 200A including
the all-optical wavelength conversion unit 13A, the WSS 230A, the cross connect 240A, and the monitoring measurement instrument 290, in which:
the all-optical wavelength conversion unit 13A converts a wavelength of the input signal to the optical transmission device 200A regardless of necessity of wavelength conversion of the input signal and outputs emission light Oout including both wavelength components before and after the wavelength conversion to the WSS 230A;
for an input signal requiring wavelength conversion, the WSS 230A outputs the wavelength component of the emission light Oout after the wavelength conversion from the cross connect 240A to an output port as the transmission signal and also outputs the wavelength component of the emission light Oout before the wavelength conversion to the monitoring measurement instrument 290 as an extraction signal, and
for an input signal not requiring wavelength conversion, the WSS 230A outputs the wavelength component of the emission light Oout before the wavelength conversion from the cross connect 240A to the output port as the transmission signal and also outputs the wavelength component of the emission light Oout after the wavelength conversion to the monitoring measurement instrument 290 as the extraction signal; and
the monitoring measurement instrument 290 electrically terminates the extraction signal output from the WSS 230A to detect transmission quality data of the extraction signal.

Therefore, the optical transmission device 200A allows all optical signals passing therethrough to pass through the all-optical wavelength conversion unit 13A, and the WSS 230A selects an appropriate transmission signal and extraction signal according to the necessity of wavelength band conversion. Therefore, the optical transmission device 200A can monitor the signal regardless of the necessity of wavelength band conversion.

In the present invention, the monitoring measurement instrument 290 handles the extraction signals output on the basis of the input signals input from a plurality of input ports in common.

Therefore, the optical transmission devices 200A to 200E can save the number of monitoring measurement instruments 290, and thus the device cost can be reduced.

In the present invention, the WSS 230A is arranged on the ingress side in the cross connect 240A.

Therefore, because the number of optical components through which optical signals pass is reduced, the optical transmission device 200B can be expected to minimize deterioration in transmission quality.

In the present invention, the optical transmission device 200C connects the DEMUX 210C on the input port side of the all-optical wavelength conversion unit 13A, and
the DEMUX 210C separates a signal including an individual wavelength component that can be converted by the all-optical wavelength conversion unit 13A from the input signal including a plurality of wavelength components and outputs the separated signal to each all-optical wavelength conversion unit 13A.

Therefore, an optical amplifier suitable for each wavelength group can be arranged on the input port side in the optical transmission device 200C.

In the present invention, the optical transmission device 200D connects the WSS 230D on the input port side of the all-optical wavelength conversion unit 13A, and
the WSS 230D demultiplexes a signal including an individual wavelength component that can be converted by the all-optical wavelength conversion unit 13A from the input signal including a plurality of wavelength components and outputs the demultiplexed signal to each all-optical wavelength conversion unit 13A.

Therefore, in the optical transmission device 200D, the number of optical components can be reduced by using the multiple-band WSS 230D than by using the single-band WSS.

In the present invention, the optical transmission device 200D connects the MUX 250C on the output port side of the cross connect 240A, and
the MUX 250C outputs, from the output port, a signal in which the transmission signals of individual wavelength components output by the cross connect 240A are multiplexed.

Therefore, an optical amplifier suitable for each wavelength group can be arranged on the output port side in the optical transmission device 200D.

### REFERENCE SIGNS LIST

11a to 11n TPD
11Aa to 11An Detector
13A All-optical wavelength conversion unit
14 Excitation light source
15 Optical fiber cable
16 Optical multiplexer
17 Nonlinear optical medium
20 Network controller
51 to 55 Optical transmission device
100 Optical transmission system
200A, 200B, 200C, 200D, 200E Optical transmission device
210A, 210B, 210C, 210E DEMUX
220A to 220E Wavelength conversion unit
230A WSS (first WSS)
241B, 241C Ingress WSS (first WSS)
241D, 241E WSS (first WSS)
250C, 250E MUX
290 Monitoring measurement instrument

1. An optical transmission device that performs optical relay processing of outputting an input signal that is an input optical signal to another device as a transmission signal, the optical transmission device comprising
a wavelength conversion unit, a first wavelength selective switch (WSS), a cross connect, and a monitoring measurement instrument, wherein:
the wavelength conversion unit converts a wavelength of the input signal to the optical transmission device regardless of necessity of wavelength conversion of the input signal and outputs emission light including both wavelength components before and after the wavelength conversion to the first WSS;
for an input signal requiring wavelength conversion, the first WSS outputs the wavelength component of the emission light after the wavelength conversion from the cross connect to an output port as the transmission signal and also outputs the wavelength component of the emission light before the wavelength conversion to the monitoring measurement instrument as an extraction signal, and
for an input signal not requiring wavelength conversion, the first WSS outputs the wavelength component of the emission light before the wavelength conversion from the cross connect to the output port as the transmission signal and also outputs the wavelength component of the emission light after the wavelength conversion to the monitoring measurement instrument as the extraction signal; and
the monitoring measurement instrument electrically terminates the extraction signal output from the first WSS to detect transmission quality data of the extraction signal.

2. The optical transmission device according to claim 1, wherein
the monitoring measurement instrument handles the extraction signals output on the basis of the input signals input from a plurality of input ports in common.

3. The optical transmission device according to claim 1, wherein
the first WSS is arranged on an ingress side in the cross connect.

4. The optical transmission device according to claim 1, wherein:
the optical transmission device connects a MUX on the output port side of the cross connect; and
the MUX outputs, from the output port, a signal in which the transmission signals of individual wavelength components output by the cross connect are multiplexed.

5. An optical transmission device that performs optical relay processing of outputting an input signal that is an input optical signal to another device as a transmission signal, the optical transmission device comprising
a wavelength conversion unit and a first WSS, wherein:
the wavelength conversion unit converts a wavelength of the input signal to the optical transmission device regardless of necessity of wavelength conversion of the input signal and outputs emission light including both wavelength components before and after the wavelength conversion to the first WSS; and
for an input signal requiring wavelength conversion, the first WSS outputs the wavelength component of the emission light after the wavelength conversion as the transmission signal and also outputs the wavelength component of the emission light before the wavelength conversion as an extraction signal, and
for an input signal not requiring wavelength conversion, the first WSS outputs the wavelength component of the emission light before the wavelength conversion as the transmission signal and also outputs the wavelength component of the emission light after the wavelength conversion as the extraction signal.

6. The optical transmission device according to claim 1, wherein:
the optical transmission device connects a DEMUX on the input port side of the wavelength conversion unit; and
the DEMUX separates a signal including an individual wavelength component that can be converted by the wavelength conversion unit from the input signal including a plurality of wavelength components and outputs the separated signal to the each wavelength conversion unit.

7.-9. (canceled)

10. The optical transmission device according to claim 5, wherein:
the optical transmission device connects a DEMUX on the input port side of the wavelength conversion unit; and
the DEMUX separates a signal including an individual wavelength component that can be converted by the wavelength conversion unit from the input signal including a plurality of wavelength components and outputs the separated signal to the each wavelength conversion unit.

11. The optical transmission device according to claim 1, wherein:
the optical transmission device connects a second WSS on the input port side of the wavelength conversion unit; and
the second WSS demultiplexes a signal including an individual wavelength component that can be converted by the wavelength conversion unit from the input signal including a plurality of wavelength components and outputs the demultiplexed signal to the each wavelength conversion unit.

12. The optical transmission device according to claim 5, wherein:
the optical transmission device connects a second WSS on the input port side of the wavelength conversion unit; and
the second WSS demultiplexes a signal including an individual wavelength component that can be converted by the wavelength conversion unit from the input signal including a plurality of wavelength components and outputs the demultiplexed signal to the each wavelength conversion unit.

13. An optical transmission method, wherein:
an optical transmission device includes a wavelength conversion unit, a first WSS, a cross connect, and a monitoring measurement instrument;
the optical transmission device performs optical relay processing of outputting an input signal that is an input optical signal to another device as a transmission signal;
the wavelength conversion unit converts a wavelength of the input signal to the optical transmission device regardless of necessity of wavelength conversion of the input signal and outputs emission light including both wavelength components before and after the wavelength conversion to the first WSS;
for an input signal requiring wavelength conversion, the first WSS outputs the wavelength component of the emission light after the wavelength conversion from the cross connect to an output port as the transmission signal and also outputs the wavelength component of the emission light before the wavelength conversion to the monitoring measurement instrument as an extraction signal, and
for an input signal not requiring wavelength conversion, the first WSS outputs the wavelength component of the emission light before the wavelength conversion from the cross connect to the output port as the transmission signal and also outputs the wavelength component of the emission light after the wavelength conversion to the monitoring measurement instrument as the extraction signal; and
the monitoring measurement instrument electrically terminates the extraction signal output from the first WSS to detect transmission quality data of the extraction signal.

14. An optical transmission method, wherein:
an optical transmission device includes a wavelength conversion unit and a first WSS;
the optical transmission device performs optical relay processing of outputting an input signal that is an input optical signal to another device as a transmission signal;
the wavelength conversion unit converts a wavelength of the input signal to the optical transmission device regardless of necessity of wavelength conversion of the input signal and outputs emission light including both wavelength components before and after the wavelength conversion to the first WSS; and
for an input signal requiring wavelength conversion, the first WSS outputs the wavelength component of the emission light after the wavelength conversion as the transmission signal and also outputs the wavelength component of the emission light before the wavelength conversion as an extraction signal, and
for an input signal not requiring wavelength conversion, the first WSS outputs the wavelength component of the emission light before the wavelength conversion as the transmission signal and also outputs the wavelength component of the emission light after the wavelength conversion as the extraction signal.
